(19) United States
(12) Patent Application Publication
(10) Pub. No.: US 2008/0208836 A1
(43) Pub. Date: Aug. 28, 2008

(54) Regression framework for learning ranking functions using relative preferences

(75) Inventors: Zhaohui Zheng, Sunnyvale, CA (US); Hongyuan Zha, Norcross, GA (US); Keke Chen, Sunnyvale, CA (US); Gordon Sun, Redwood Shores, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc.

(21) Appl. No.: 11/710,097

(22) Filed: Feb. 23, 2007

(51) Int. Cl. G06F 17/30

(52) U.S. Cl. 707/5; 707/E17.108

(57) ABSTRACT

A method and apparatus for determining a ranking function by regression using relative preference data. A number of iterations are performed in which to following is performed. The current ranking function is used to compare pairs of elements. The comparisons are checked against actual preference data to determine for which pairs the ranking function mis-predicted (contradicting pairs). A regression function is fitted to a set of training data that is based on contradicting pairs and a target value for each element. The target value for each element may be based on the value that the ranking function predicted for the other element in the pair. The ranking function for the next iteration is determined based, at least in part, on the regression function. The final ranking function is established based on the regression functions. For example, the final ranking function may be based on a linear combination of regression functions.

### FIELD OF THE INVENTION

The present invention relates to functions that can be used to rank elements. In particular, the present invention relates to applying regression using relative preferences to learn a ranking function.

### BACKGROUND

Web search engines typically employ a ranking function to determine the relevance of the search results. Thus, ranking functions are at the core of search engines and they directly influence the relevance of the search results and users' search experience. Many models and methods for designing ranking functions have been proposed, including vector space models, probabilistic models and language modeling-based methodologies. In particular, using machine learning to determine ranking functions has attracted much interest.

Machine learning approaches for learning ranking functions entail the generation of training data, which can include labeled data explicitly constructed from relevance assessments by human editors. As an example, an individual assigns an absolute relevance judgment such as perfect, good, or bad to each document with respect to a query indicating the degree of relevance each particular document has to the query. Each document is associated with a feature vector that describes features of the document. The ranking function is learned by mapping the feature vectors to their relevance labels. However, acquiring large quantities of absolute relevance judgments can be very costly because it is necessary to cover a diverse set of queries in the context of Web searches. An additional issue is the reliability and variability of absolute relevance judgments.

One possibility to alleviate these problems is to use data that describes user interactions with the search results, for example, user “click-through” data. In other words, when a user receives a page of search results for a search query, the user will click on some results but not others. This click-through data can be used to assess whether one search result is more relevant to the search query than another search result. Thus, rather than determining an absolute measure of relevance, a relative relevance judgment describes whether a document is more relevant than another document with respect to a query.

Possible benefits of using relative relevance judgments include the potentially unlimited supply of user click-through data and the timeliness of user click-through data for capturing user searching behaviors and preferences. However, possible drawbacks of using relative relevance judgments are that user click-through data tends to be quite noisy, and some click-through data may represent user errors.

Once relative relevance judgments are extracted from user click-through data, the next question is how to use the relative relevance judgments for the purpose of learning a ranking function. Several algorithms have been proposed. However, the proposed techniques suffer from various problems including lack of flexibility, inability to deal with some types of feature vectors, and inability to deal with complicated features used in Web search context.

Therefore, improved techniques are desired for learning a ranking function. Improved techniques are also desired for learning ranking functions for use by search engines that serve a diverse stream of user queries.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating a method of determining a ranking function, in accordance with an embodiment of the present invention; and

FIG. 2 is a block diagram of an example computer system upon which embodiments of the present invention may be practiced.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Determining a ranking function by determining a series of regression functions using a set of relative preference data is disclosed herein. The ranking function can be used by a search engine to rank the documents based on the relevance to search queries; however, the present invention is not so limited. In one embodiment, a number of iterations are performed such that a new regression function is learned each iteration. The ranking function is based on a linear combination of the regression functions, in this embodiment.

In one embodiment, the goal is for the ranking function to match a set of preferences that defines how relevant documents are to a search query. More particularly, the set of preferences describes, for each pair of documents, which document is considered to be more relevant to the search query. Thus, the preference data may be termed “relative preference data.” The ranking function is learned over a series of iterations by using regression and the relative preference data.

For a given query, each document is associated with a feature vector, which describes features of that document and the search query. In each iteration, the current ranking function is applied to every pair of feature vectors (“vector pair”), in which one feature vector is more relevant to the query than the other feature vector. The result is that the ranking function predicts, for every pair of documents, which document is preferred in terms of relevance (“predicted result”). Each predicted result is compared with the actual preference in the set of preferences to divide the vector pairs into two disjoint sets. One set includes the vector pairs for which the current ranking function accurately predicted the preference, and the other set includes vector pairs for which the prediction contradicted the actual preferences. The term “contradicting pairs” is used herein to refer to the vector pairs that were mis-predicted.

Then, a regression function g is fitted to a set of training data that is based on the contradicting pairs. In one embodiment, the target value for each vector is based on the value that the ranking function predicted for the other vector in the vector pair.

If there are more iterations to perform, the next ranking function is determined based, at least in part, on the regression function. For example, the next ranking function is determined based on a linear combination of all regression functions learned up to the current iteration.

When there are no further iterations to perform, then the ranking function is established to be the final ranking function.

### Features Vectors

Feature vectors are used to learn the ranking function, in one embodiment. A feature vector is an n-dimensional vector that represents some object. In one embodiment, the feature vector pertains to a document (e.g., a web page) and a search query. Herein, this is referred to as a “query-document pair.” In this embodiment, a feature vector may include features that depend only on the query, x^{Q}, that depend only on the document, x^{D}, or that depend on both the query and the document, x^{QD}. In one embodiment, the feature vector comprises the following three different feature vectors [x^{Q}, x^{D}, x^{QD}].

The query-feature vector x^{Q} comprises features dependent on the query only. The features have constant values across all the documents. Examples include the number of terms in the query, whether or not the query is a person name, etc.

The document-feature vector x^{D} comprises features dependent on the document only. The features have constant values across all the queries. Examples include the number of inbound links pointing to the document and the language identity of the document, etc.

The query-document feature vector x^{QD} comprises features dependent on the relation of the query with respect to the document. Examples include the number of times each term in the query appears in the document, the number of times each term in the query appears in the anchor-texts of the document, etc.

More generally, the features vectors may pertain to any object, and are thus not limited to query-document pairs.

### Preference Data

In one embodiment, the preference data contains judgments, for each pair of documents, as to which document is more relevant with respect to a query. Because each document has a feature vector associated therewith, the judgment that compares the relative relevance of two documents to a particular query is based on two feature vectors. For example, given feature vectors “x” and “y” for two query-document pairs, the notation x→y means that x is preferred over y, i.e., x should be ranked higher than y. In other words, this means that the document represented by vector x is considered more relevant than that represented by vector y with respect to the query in question.

The set of available preferences (S) based on the relative relevance judgments is denoted in Equation 1 as:

S={(xᵢ, yᵢ)|xᵢ→yᵢ, i=1, . . . , N} Equation 1

### Process for Learning a Ranking Function

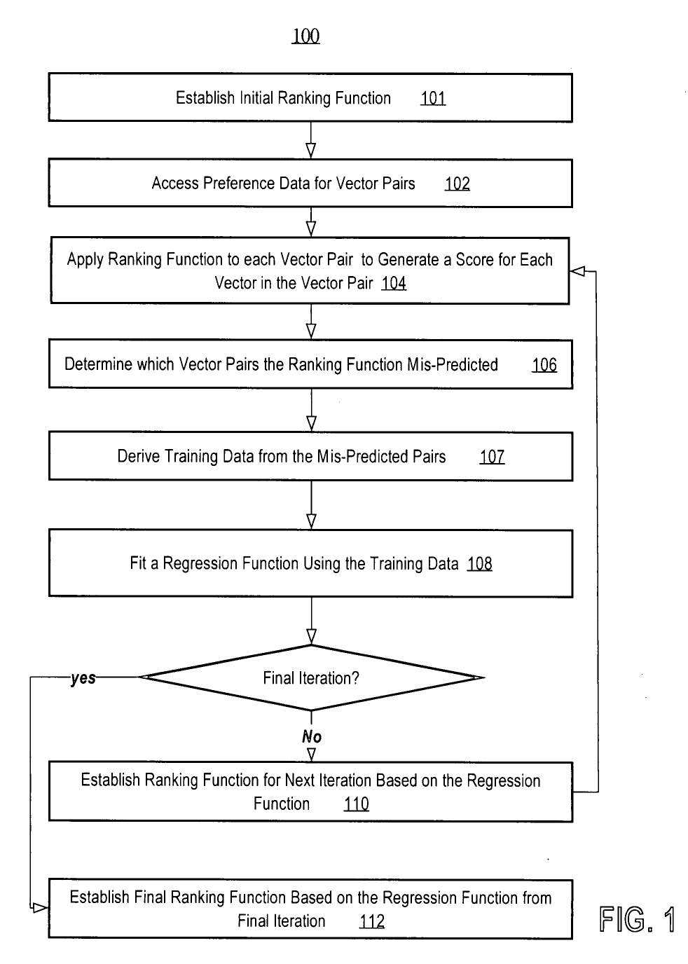

FIG. 1 is a flowchart illustrating a process 100 of determining a ranking function, in accordance with an embodiment of the present invention. For the sake of illustration, process 100 will use an example in which the ranking function (h) is used to rank the relevance of documents to a search query. However, process 100 is not limited to ranking documents. In step 101, an initial ranking function h₀ is generated. The ranking function h₀ for the first iteration may be established arbitrarily. In step 102, a set of preference data is accessed. The preference data describes, for pairs of documents, which of the documents is more relevant to a search query, in one embodiment.

Steps 104-110 are performed for a series of iterations to gradually learn the ranking function. Within each iteration “i”, the ranking function is adjusted based on fitting a regression function gᵢ to a set of training data derived from the contradicting pairs. In step 104, the current ranking function hᵢ is applied to feature vectors to generate a score for each vector in the vector pair. By comparing the scores, a prediction is made as to which document in each pair is more relevant to the search query. The term “predicted preference data” is used herein to refer to the set of data containing pairwise preference predicted by the ranking function. After the first iteration, the ranking function learned from the previous iteration is reapplied to the feature vectors.

In step 106, the predicted preference data is compared to the labeled preference data to determine which of the feature vector pairs were mis-predicted by the ranking function. For example, if the ranking function for this iteration predicted that document A is more relevant to the search query than document B, but the preference data indicates otherwise, then the ranking function mis-predicted the vector pair corresponding to the documents. The term “contradicting pairs” is used herein to refer to the vector pairs that were mis-predicted.

In step 107, training data is derived from the contradicting pairs. The training data includes (xᵢ, tᵢ), where xᵢ is one vector in a pair and tᵢ is the adjusted target value for that vector.

In step 108, a regression function (gᵢ) is fitted using the training data. In one embodiment, determining the regression function is performed using gradient boosting trees (GBT). However, other techniques may be used, too. In one embodiment, the target value for a vector is based on the predicted preference data for the current iteration for the other vector in the pair. For example, assuming in the preference data, xᵢ is more relevant than yᵢ and h is the current ranking function such that h(yᵢ)>h(xᵢ), the target value for vector xᵢ is established as h(yᵢ)+τ and that for vector yᵢ is established as h(xᵢ)−τ, where τ is a regularization parameter. The regularization parameter is a constant, in one embodiment. As an example, τ could be a constant value such as 0.1; however, another value might be used. Equation 2 describes training data that is to be fitted at each iteration, where “k” refers to the iteration.

{(xᵢ, hₖ₋₁(yᵢ)+τ), (yᵢ, hₖ₋₁(xᵢ)−τ)} Equation 2

In Equation 2, the set of vector pairs (xᵢ, yᵢ) contains all the vector pairs that are contradicting pairs for the current iteration, and hₖ₋₁(yᵢ)+τ is the adjusted target value for xᵢ, in one embodiment. Typically, the number of contradicting pairs shrinks each iteration, although this may not always be the case. In another embodiment, the training data includes the contradicting pairs for each iteration. Thus, in this embodiment, the training data grows with each iteration even if the number of contradicting pairs shrinks.

If there is another iteration to be performed, then the ranking function for the next iteration is established based, at least in part, on the regression function gᵢ for the current iteration. In one embodiment, the ranking function for the next iteration is established based, at least in part, on a linear combination of the regression function learned in each iteration. For example, Equation 3 describes how the next ranking function hₖ(x) is formed in accordance to one embodiment.

hₖ(x)=hₖ₋₁(x)+μ* gₖ(x) Equation 3

In Equation 3, gₓ(x) is the regression function that was fit in the current iteration. The i term is a “shrinking factor.” The shrinking factor is typically a value that is the same in each iteration of process 100. However, it is not required that the shrinking factor be the same for each iteration. Based on an analysis of the results of process 100, the shrinking factor can be fine-tuned. Note that because the ranking function from the current iteration hₖ is based on the regression function from a prior iteration gₖ₋₁, the next ranking function hₖ is based on a linear combination of the regression functions learned at each iteration.

If a further iteration is to be performed, control passes to step 104, where the next ranking function is applied to the vector pairs. When the final iteration is complete, the final ranking function is established based on the regression function from the final iteration, in step 112. In one embodiment, the final ranking function is a linear combination of all of the regression functions as Equation 3 shows. In this embodiment, the training data for each iteration is based on contradicting pairs for that iteration.

In another embodiment, the final ranking function is not formed from a linear combination of all of the regression functions. Rather, the training data grows with each iteration such that the training data includes the contradicting pairs for each iteration up to that point. In this embodiment, the final ranking function may be based on the final regression function, without directly taking into account the previous regression functions.

### Risk Function

As previously discussed, learning a ranking function is performed by computing a ranking function h. The ranking function is an element of H, which is a given function class, with the goal that the ranking function matches the set of preferences. That is, h(xᵢ)≧h(yᵢ), if xᵢ→yᵢ, i=1, . . . , N. It will be understood that the ranking function may not produce matches for all members of the set of preferences. The following objective function R can be used to measure the risk of a ranking function h.

$$R ( h ) = 1 / 2 {\sum }_{i = 1}^{N} {( max \{ 0 , h ( {y}_{i} ) - h ( {x}_{i} ) \} )}^{2} \qquad Equation 4$$

The motivation is that if a particular pair (xᵢ, yᵢ) matches the given preference, i.e., h(xᵢ)≧h(yᵢ), then h incurs no cost on the pair. Otherwise the cost is given by (h(yᵢ)−h(xᵢ))². In one embodiment, to optimize R(h) one or both of the values h(xᵢ) or h(yᵢ) is corrected during regression.

### Gradient Descent

In one embodiment, the above correction to optimize R(h) is performed using a functional gradient descent. The gradient of R(h) is computed with respect to the unknowns in Equation 5.

h(xᵢ), h(yᵢ), I=1, . . . , N Equation 5

The components of the negative gradient corresponding to h(xᵢ) and h(yᵢ), respectively are given in Equations 6 and 7.

max{0, h(yᵢ)−h(xᵢ)} Equation 6

−max {0, h(yᵢ)−h(xᵢ)} Equation 7

Equations 6 and 7 are equal to zero when h matches the pair (xᵢ, yᵢ), and therefore, in this case no modification is needed for the components corresponding to h(xᵢ) or h(yᵢ). On the other hand, if h does not match the pair (xᵢ, yᵢ), the components of the gradient are given by Equations 8 and 9.

h(yᵢ)−h(xᵢ) Equation 8

h(xᵢ)−h(yᵢ) Equation 9

Equations 8 and 9 describe how to modify the difference of function values for xᵢ and yᵢ, respectively. To know how to modify the ranking function, the gradient components are translated into modifications to h. As previously discussed, the following approach is used to modify the ranking function h. The target value for xᵢ is set as h(yᵢ)+τ and the target value for yᵢ is set as h(xᵢ)−τ, where τ is a regularization parameter.

### Same Feature Vector Appearing More Than Once in the Set of Preferences

When some feature vectors xᵢ or yᵢ can appear more than once in the preference data, there will be several components of the negative gradient of R(h) that will involve xᵢ or yᵢ. Thus, translating the gradient components to modification of the ranking function h may result in inconsistent requirements. In one embodiment, an average is computed taking into account of all the requirements. This approach uses information in the training data related to the feature vectors in question. In another embodiment, all the different and potentially inconsistent requirements are included in the training data, and a regression technique is used to handle the inconsistency. For example, a regression technique based on gradient boosting trees can be used.

### Collecting Preference Data From Labeled Data

The data for the preference data can be based on labeled data as follows. A set of queries are sampled from query logs, and a certain number of query-document pairs are labeled according to their relevance judged by human editors. A grade (e.g., 0 to 4) is assigned to each query-document pair based on the degree of relevance (perfect match, excellent match, etc), and the numerical grades are also used as the target values for regression. The labeled data can be used to generate a set of preference data as follows. Given a query q and two documents dₓ and d_{y}, 1 et the feature vectors for (q, dₓ) and (q, d_{y}) be x and y, respectively. If dₓ has a higher grade than d_{y}, the preference is established as x→y, whereas if d_{y} has a higher grade than dₓ, the preference is established as y→x. Pairs of documents with equal grades can be ignored.

### Collecting Preference Data From Click-Through Data

The data for the preference data can be based on user click-through data as follows. If a user is presented a page of search results and clicks through to document d₁ while not clicking through to document d₂ this is evidence that d₁ is preferred over d₂, at least for this user. For a query q, consider two documents d₁ and d₂ in the search result set for q. Assume that d₁ has c₁ click-throughs out of n₁ impressions, and d₂ has c₂ click-throughs out of n₂ impressions. An impression refers to the number of times a user was provided a page of search results containing the particular document. Document pairs d₁ and d₂ for which either d₁ or d₂ is significantly better than the other in terms of click-through rate are included in the preference data.

One technique for extracting preference data from click-through data is described in “Accurately Interpreting Click-through Data as Implicit Feedback”, (Joachims, L. Granka, B. Pang, H. Hembrooke, and Gay), Proceedings of the Annual International ACM SIGIR Conference on Research and Development in Information Retrieval, 2005. However, other techniques could be used to extract preference data from click-through data.

### Weighing Error Terms

As previously mentioned, absolute relevance data can be used to determine relative preference data. When converting absolute relevance data to relative preference data, the document pairs with larger grade difference are overweighed in one embodiment. For example, in Equation 2, the vectors (xᵢ, yᵢ) can each be assigned a weight.

In one embodiment, each error term in the loss function defined in Equation 4 is weighed. Specifically, assume in the current iteration two documents d₁ and d₂ were ranked at position i and j respectively, where i<j. Suppose the resulted predicted preference contradicts with the true preference. Their contribution with respect to the wrong ordering would be:

G(dᵢ)/(log₂(i+1))+G(d₂)/(log₂(j+1))

However, their contribution with respect to the correct ordering should be:

G(d₁)/(log₂(j+1))+G(d₂)/(log₂(i+1))

The difference caused by the wrong ordering is therefore:

G(d₁)−G(d₂)|[1/(log₂(i+1))−1/(log₂(j+1))].

During training, each error term is weighed according to that difference. When the absolute relevance judgments are not available, the term |G(d₁)−G(d₂)| can be removed.

### Using Preference Data Having Equal Preference

In one embodiment, tied data pairs (xᵢ, yᵢ) are included in the training data. That is, rather than just using contradicting pairs, pairs for which neither document is preferred are included in the training data. In one embodiment, the following is added to the set in Equation (2) to construct the training, resulting in Equation 10.

{(xᵢ, (hₖ₋₁(xᵢ)+hₖ₋₁(yᵢ))/2), (yᵢ, (hₖ₋₁(xᵢ)+hₖ₋₁(yᵢ))/2)} Equation 10

### Combining Relative and Absolute Judgments

In one embodiment, both relative relevance judgments and absolute relevance judgments are used to learn the ranking function. For any query-document feature vector xᵢ and its absolute relevance judgment gᵢ, the training data (xᵢ, gᵢ) is added to the set in Equation 2, and there is no need to modify the objective function (described in Equation 4). Such flexibility is desirable considering there are many queries having a single document with absolute relevance judgment (or documents with same absolute relevance judgment).

### Hardware Overview

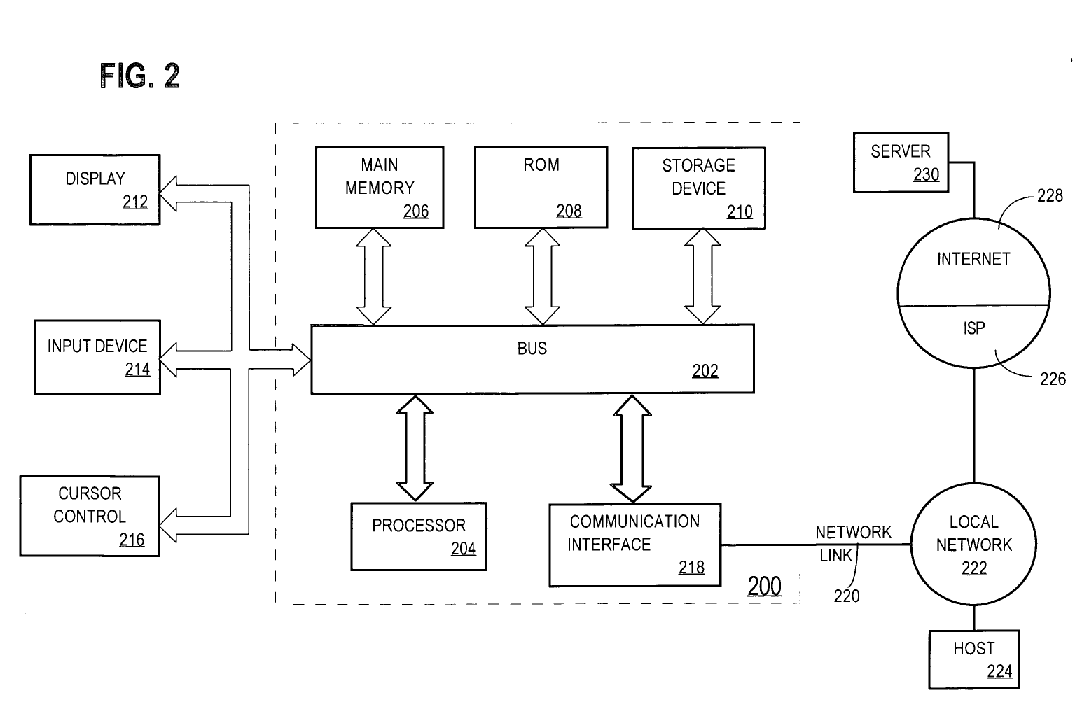

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane. 10058] The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to, non-volatile media, volatile media, and transmission media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
accessing first preference data that includes, for each of a plurality of pairs of elements, a comparison of a first element to a second element of each pair;
performing iterations of the following steps:
based on a ranking function for a current iteration, generating predicted preference data for each pair in the preference data, wherein the predicted preference data compares the first element to the second element of each pair;
determining for which of the pairs the predicted preference data for the current iteration contradicts the first preference data;
fitting a regression function using training data, wherein the training data is derived from each pair for which the predicted preference data for at least the current iteration contradicts the first preference data; and
if a next iteration is to be performed, establishing the ranking function for the next iteration based, at least on the regression function for the current iteration; and
after a final iteration is complete, establishing a final ranking function based, at least in part, on the regression function from the final iteration.

2. The method of claim 1, wherein the training data contains data for each pair for which the predicted preference data for any of the iterations contradicts the first preference data.

3. The method of claim 1, wherein establishing the ranking function for the next iteration is further based on the ranking function from the current iteration.

4. The method of claim 1, wherein the training data for the current iteration includes a target value for each element of each pair for which the predicted preference data for the current iteration contradicts the first preference data.

5. The method of claim 4, wherein the target value for a first element of a particular pair for which the predicted preference data for the current iteration contradicts the first preference data is based on a value assigned to a second element of the particular pair by the ranking function of the current iteration.

6. The method of claim 1, wherein the predicted preference data defines which element of a particular pair is more relevant to a condition than the other element of the particular pair.

7. The method of claim 1, wherein the predicted preference data defines which of two web documents is more relevant to a particular search query.

8. The method of claim 1, wherein each element of any pair is a feature vector that pertains to a search query and a matching document.

9. An apparatus comprising:
a processor; and
a computer readable medium having instructions stored thereon that when executed on the processor cause the processor to execute the steps of:
accessing first preference data that includes, for each of a plurality of pairs of elements, a comparison of a first element to a second element of each pair;
performing iterations of the following steps:
based on a ranking function for a current iteration, generating predicted preference data for each pair in the preference data, wherein the predicted preference data compares the first element to the second element of each pair;
determining for which of the pairs the predicted preference data for the current iteration contradicts the first preference data;
fitting a regression function using training data, wherein the training data is derived from each pair for which the predicted preference data for at least the current iteration contradicts the first preference data; and
if a next iteration is to be performed, establishing the ranking function for the next iteration based, at least on the regression function for the current iteration; and
after a final iteration is complete, establishing a final ranking function based, at least in part, on the regression function from the final iteration.

10. The apparatus of claim 9, wherein the training data contains data for each pair for which the predicted preference data for any of the iterations contradicts the first preference data.

11. The apparatus of claim 9, wherein the instructions that cause the processor to perform the step of establishing the ranking function for the next iteration include instructions that cause the processor to establishing the ranking function based on the ranking function from the current iteration.

12. The apparatus of claim 9, wherein the training data for the current iteration includes a target value for each element of each pair for which the predicted preference data for the current iteration contradicts the first preference data.

13. The apparatus of claim 12, wherein the target value for a first element of a particular pair for which the predicted preference data for the current iteration contradicts the first preference data is based on a value assigned to a second element of the particular pair by the ranking function of the current iteration.

14. The apparatus of claim 9, wherein the predicted preference data defines which element of a particular pair is more relevant to a condition than the other element of the particular pair.

15. The apparatus of claim 9, wherein the predicted preference data defines which of two web documents is more relevant to a particular search query.

16. The apparatus of claim 9, wherein each element of any pair is a feature vector that pertains to a search query and a matching document.

17. A computer readable medium having instructions stored thereon that when executed on the processor cause the processor to execute the steps of:
accessing first preference data that includes, for each of a plurality of pairs of elements, a comparison of a first element to a second element of each pair;
performing iterations of the following steps:
based on a ranking function for a current iteration, generating predicted preference data for each pair in the preference data, wherein the predicted preference data compares the first element to the second element of each pair;
determining for which of the pairs the predicted preference data for the current iteration contradicts the first preference data;
fitting a regression function using training data, wherein the training data is derived from each pair for which the predicted preference data for at least the current iteration contradicts the first preference data; and
if a next iteration is to be performed, establishing the ranking function for the next iteration based, at least on the regression function for the current iteration; and
after a final iteration is complete, establishing a final ranking function based, at least in part, on the regression function from the final iteration.

18. The computer readable medium of claim 17, wherein the training data contains data for each pair for which the predicted preference data for any of the iterations contradicts the first preference data.

19. The computer readable medium of claim 17, wherein the instructions that cause the processor to perform the step of establishing the ranking function for the next iteration include instructions that cause the processor to establishing the ranking function based on the ranking function from the current iteration.

20. The computer readable medium of claim 18, wherein the training data for the current iteration includes a target value for each element of each pair for which the predicted preference data for the current iteration contradicts the first preference data.
